(19) United States
(12) Patent Application Publication
(10) Pub. No.: US 2025/0202992 A1
(43) Pub. Date: Jun. 19, 2025

(54) ZERO-BYTE FILENAME-BASED TELEMETRY

(71) Applicant: Snowflake Inc., Bozeman, MT (US)

(72) Inventors: Nathan Hunt, Santa Monica, CA (US); Julio Merino, Redmond, WA (US); Daniel Armando Sada Caraveo, Kirkland, WA (US)

(21) Appl. No.: 18/539,718

(22) Filed: Dec. 14, 2023

(51) Int. Cl. H04L 67/50; G06F 16/16; H04L 67/75

(52) U.S. Cl. CPC H04L 67/535; G06F 16/164; H04L 67/75

(57) ABSTRACT

Techniques for generating and storing application telemetry data are described. An example method includes generating, by an application, a unit of telemetry data comprising metrics related to a runtime state of the application. The method also includes generating a character string comprising the metrics. The method also includes writing, by a processing device executing the application, a zero-byte file to a storage system using the character string as a file name of the zero-byte file.

### TECHNICAL FIELD

Aspects of the present disclosure relate to application telemetry, and more specifically, to techniques for generating, storing, and collecting application telemetry data.

### BACKGROUND

An application telemetry system may be used to monitor computer processes (e.g., software applications and services) and collect various types of data relevant to the execution of the computer process. Such data, often referred to as telemetry or telemetry data, can include substantially any type and/or combination of metrics related to the runtime state of application, including the application's usage, performance, resource consumption, runtime errors, security information, system information of the host running the application (e.g., operating system and version, type of hardware, etc.), and others. The telemetry data may be stored as metrics that can be analyzed to help determine the software application's performance and behavior, for example.

Some telemetry systems may be configured to collect telemetry data for cloud-native applications operating in distributed computing systems. For example, cloud-based data storage and processing systems use cloud computing resources to efficiently manage, process, and analyze large volumes of data. These systems offer businesses and organizations the ability to securely store and access data on remote cloud servers, eliminating the need for on-premises hardware and infrastructure.

A telemetry system for a cloud-based data storage and processing system may collect various types of telemetry, including customer usage metrics, which may be used for various purposes such as determining how much to charge for the usage of a service, the popularity of a service, and others. Customer usage metrics may include quantitative measurements that track and analyze how customers interact with the cloud-based data storage and retrieval system, encompassing factors such as data consumption rates, user activity, and resource utilization. Customers may evaluate their usage metrics for managing costs, optimizing workflows, monitoring performance, resource allocation, capacity planning, security compliance, and others.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram of an example computing environment, in accordance with some embodiments of the present disclosure.

FIG. 2 is a block diagram that illustrates an example system for storing telemetry data, in accordance with some embodiments of the present disclosure.

FIG. 3 is an example file path format for storing telemetry data to a file system, in accordance with some embodiments of the present disclosure.

FIG. 4 is a more detailed example of a file path that may be used for storing telemetry data to a file system, in accordance with some embodiments of the present disclosure.

FIG. 5 is a flow diagram of a method of storing telemetry data, in accordance with some embodiments of the present disclosure.

FIG. 6 illustrates a diagrammatic representation of a machine in the example form of a computer system within which a set of instructions, for causing the machine to perform any one or more of the methodologies discussed herein for intelligently scheduling containers.

### DETAILED DESCRIPTION

Generating and collecting telemetry data for software processes provides various benefits. Telemetry data can be used to analyze application performance, usage, and behavior and thereby develop improvements to the user experience. In cloud-based data storage and retrieval systems, a telemetry system can be used to collect customer usage metrics, which may be used by customers and/or by service providers for various tasks such as determining service charges or determining the popularity of an application (or features thereof), for example.

Logging telemetry data about the usage of interactive tools can be costly, resource intensive, and time consuming. One technique for logging telemetry data involves connecting to a remote server, sending data logging requests, and storing the metrics data to a complex storage database such as a relational database. Once the metrics are stored, they can be retrieved using tools designed to query the data. Another alternative for logging telemetry data is to configure the application to create files in a shared cloud-based storage system. This bypasses the need for a logging service and a complex storage database. However, cloud-based storage systems usually distribute data across multiple networked storage devices, which makes data retrieval relatively time-consuming, especially in the presence of high network latency. Furthermore, file access may be slowed by file contention issues when multiple users attempt to access the same file. Additionally, cloud-based data services such as Amazon Web Services (AWS) and others charge fees proportional to the amount of data stored to their systems.

The present disclosure addresses the above-noted and other deficiencies by using a processing device to generate telemetry data and store the telemetry data in the file name of a zero-byte file. The application or service to be monitored is configured to generate the telemetry data and send the data to a shared storage space in the form of a zero-byte file (also known as a zero-length file), which is a computer file that contains no data. The telemetry data may be included within the file name of the zero-byte file rather than in the contents of the file. As long as clients have the right credentials to access a shared storage system, the client's applications can emit telemetry data with simple writes to the file system by picking globally-unique filenames.

The stored telemetry data can be retrieved through enumeration of the file system's directories and files without the need to fetch individual file contents. This file system information will often be stored in a single server (sometimes referred to as a “master node” or “metadata node”). In such cases, the file system information, unlike file contents, can be retrieved without accessing multiple storage devices within a distributed network. This makes accessing the zero-byte telemetry data exceedingly fast and efficient. In some large-scale data storage services, the file system information may be distributed between a plurality of physical servers. However, even in these cases, the retrieval of file system information from two or more physical servers will be much faster than accessing the corresponding data files, which may be distributed across an even greater number of storage devices. In either case, since the telemetry data is accessed without retrieving file contents, file contention problems are avoided. Additionally, since the data is captured in the file name, the file itself will have a lower net file size, which may be less expensive in cloud storage.

Human inspection of the stored telemetry data may be accomplished using list-style commands (e.g., “Is” commands) to list the files and directories of the file system without opening individual files. The stored telemetry data may also be collected by performing a simple range scan of the file system, parsing the file names to extract the data, and importing the data into a database for further processing and analysis.

As discussed herein, the present disclosure improves the operation of a computer system by providing an improved approach to the storage and retrieval of telemetry data. Embodiments of the present techniques may be deployed in any computing device configured to generate and deliver telemetry data of an application or service. The disclosed techniques may be particularly useful for storing telemetry data of cloud-native applications operating in distributed computing environments such as cloud-based data storage and retrieval systems. However, embodiments of the present techniques may also be implemented in personal computers, smart phones, and other computing devices configured to generate and deliver telemetry data. As used herein, the terms “application” and “service” may be used interchangeably and refer to processes implemented by computer instructions executing on a processing device. Additionally, the term “metrics” is used to herein refer to any type of telemetry data that may be generated by an application during execution, including data sometimes referred to as logs and traces.

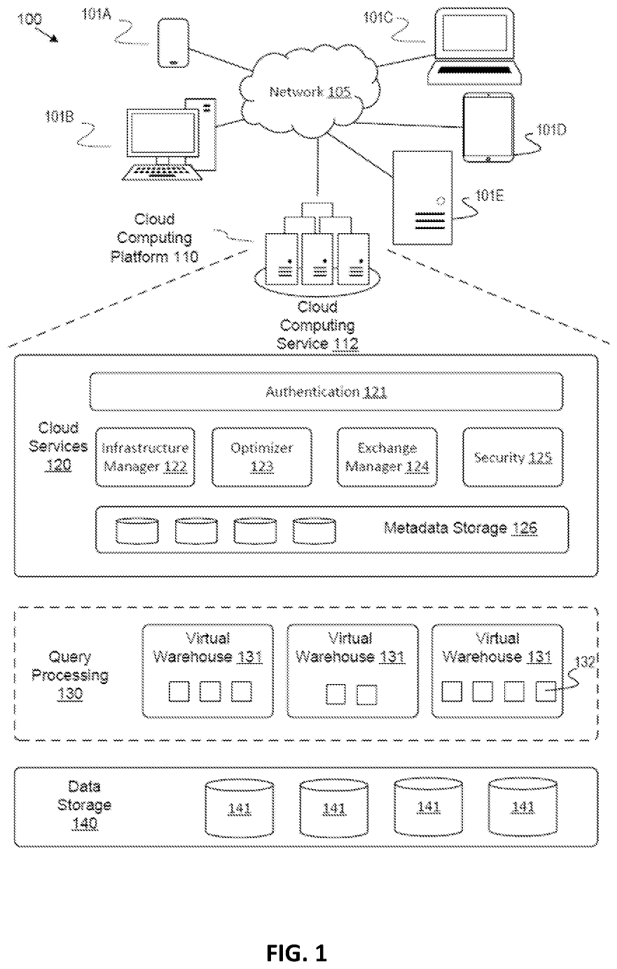

FIG. 1 is a block diagram of an example computing environment 100, in accordance with some embodiments of the present disclosure. In particular, a cloud computing platform 110 may be implemented, such as AMAZON WEB SERVICES™ (AWS), MICROSOFT AZURE™, GOOGLE CLOUD™ or GOOGLE CLOUD PLATFORM™, or the like. The cloud computing platform 110 provides computing resources and storage resources that may be acquired (purchased) or leased and configured to execute applications and store data. The cloud computing platform 110 may be accessed by a client device 101. Non-limiting examples of client devices include a smart phone 101A, personal computer 101B, laptop 101C, tablet computer 101D, server computer 101E, and/or another type of device that can process data. FIG. 1 and the other figures may use like reference numerals to identify like elements. A letter after a reference numeral, such as “101A,” indicates that the text refers specifically to the element having that particular reference numeral. A reference numeral in the text without a following letter, such as “101,” refers to any or all of the elements in the figures bearing that reference numeral.

In some embodiments, client devices 101 may access the cloud computing platform 110 over a network 105. Network 105 may be a public network (e.g., the Internet), a private network (e.g., a local area network (LAN) or wide area network (WAN)), or a combination thereof. In one embodiment, network 105 may include a wired or a wireless infrastructure, which may be provided by one or more wireless communications systems, such as a WIFI® hotspot connected with the network 105 and/or a wireless carrier system that can be implemented using various data processing equipment, communication towers (e.g., cell towers), etc. The network 105 may carry communications (e.g., data, message, packets, frames, etc.) between the various components of the cloud computing platform 110 and one more of the client devices 101.

The cloud computing platform 110 may host a cloud computing service 112 that facilitates storage of data on the cloud computing platform 110 (e.g., data management and access) and analysis functions (e.g., SQL queries, analysis), as well as other computation capabilities (e.g., secure data sharing between users of the cloud computing platform 110). The cloud computing platform 110 may include a three-tier architecture: data storage 140, query processing 130, and cloud services 120.

Data storage 140 may facilitate the storing of data on the cloud computing platform 110 in one or more cloud databases 141. Data storage 140 may use a storage service such as AWS S3 to store data and query results on the cloud computing platform 110. In particular embodiments, to load data into the cloud computing platform 110, data tables may be horizontally partitioned into large, immutable files which may be analogous to blocks or pages in a traditional database system. Within each file, the values of each attribute or column are grouped together and compressed using a scheme sometimes referred to as hybrid columnar. Each table has a header which, among other metadata, contains the offsets of each column within the file.

In addition to storing table data, data storage 140 facilitates the storage of temporary data generated by query operations (e.g., joins), as well as the data contained in large query results. This may allow the system to compute large queries without out-of-memory or out-of-disk errors. Storing query results this way may simplify query processing as it removes the need for server-side cursors found in traditional database systems.

Query processing 130 may handle query execution by compute nodes within elastic clusters of virtual machines, referred to herein as virtual warehouses or data warehouses. Thus, query processing 130 may include one or more virtual warehouses 131 having one or more compute nodes 132, which may also be referred to herein as data warehouses. The virtual warehouses 131 may be one or more virtual machines operating on the cloud computing platform 110. The virtual warehouses 131 may be compute resources that may be created, destroyed, or resized at any point, on demand. This functionality may create an “elastic” virtual warehouse 131 that expands, contracts, or shuts down according to the user's needs. Expanding a virtual warehouse 131 involves generating one or more compute nodes 132 to the virtual warehouse 131. Contracting a virtual warehouse 131 involves removing one or more compute nodes 132 from the virtual warehouse 131. More compute nodes 132 may lead to faster compute times. For example, a data load which takes fifteen hours on a system with four nodes might take only two hours with thirty-two nodes.

Cloud services 120 may be a collection of services (e.g., computer instruction executing on a processing device) that coordinate activities across the cloud computing service 112. These services tie together all of the different components of the cloud computing service 112 in order to process user requests, from login to query dispatch. Cloud services 120 may operate on compute instances provisioned by the cloud computing service 112 from the cloud computing platform 110. Cloud services 120 may include a collection of services that manage virtual warehouses, queries, transactions, data exchanges, and the metadata associated with such services, such as database schemas, access control information, encryption keys, and usage statistics. Cloud services 120 may include, but not be limited to, an authentication engine 121, an infrastructure manager 122, an optimizer 123, an exchange manager 124, a security engine 125, and/or a metadata storage 126. In some embodiments, the cloud services 120 may include a collection of microservices that operate together to build, deploy, and manage cloud-native applications.

Any of the cloud services 120 may be configured to generate telemetry data including execution logs, trace events, and metrics (referred to herein collectively as metrics). The telemetry data can help a service provider understand how consumers are using and interacting with their data and/or services and provide an indication of the resources (e.g., compute, storage resources) required to run applications, process queries, etc. Access to telemetry data can also support first level debugging and other management of applications and data.

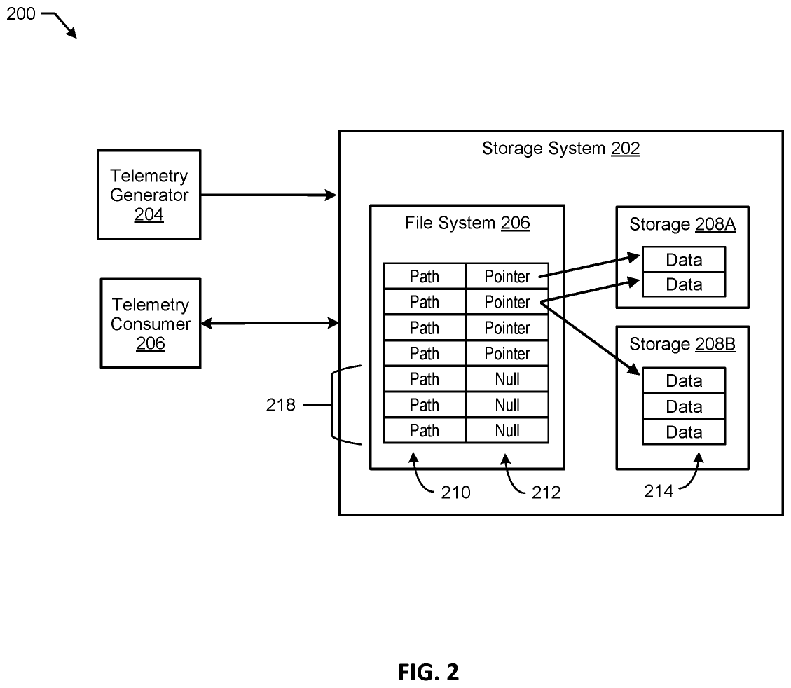

The telemetry data may be stored to a shared dataset by writing zero-byte files to the storage service that manages the data storage 140. Techniques for organizing, formatting, and storing telemetry data are described further in relation to FIGS. 2-4.

FIG. 2 is a block diagram that illustrates an example system for storing telemetry data, in accordance with some embodiments of the present disclosure. The system of FIG. 2 includes a storage system 202 operatively coupled to a telemetry generator 204 and a telemetry consumer 206. The telemetry generator 204 may be any application or service that, in addition to its primary function or functions, also generates telemetry data related to the state of the application or service, such as resource consumption, usage, and other metrics, including those described herein and others.

In some embodiments, the storage system 202 may be implemented in a cloud-computing environment (e.g., data storage 140). In such embodiments, the telemetry generator 204 may be a cloud service 120 or other application executing within the same cloud-computing environment. For example, if the telemetry generator 204 is a cloud service 120 that functions as a query processor, the cloud service 120 may be configured to generate and store usage-data related to the processing of queries received from users.

In other embodiments, the telemetry generator 204 may be an application (user application, operating system service, etc.) running on a user's computing device (e.g., client device 101). In such embodiments, the storage system 202 may be implemented in a cloud-computing environment (e.g., data storage 140) or other type of remote storage system (e.g., server, Network Attached Storage (NAS), and others). In some embodiments, the telemetry generator 204 may access the storage system 202 through a file system API made available by the cloud service provider. Storage resources of the storage system 202 may be mounted so that it operates like a local drive or local folder from the perspective of the telemetry generator 204. In this way, the telemetry generator 204 can be programmed to record telemetry data using simple commands for creating new files.

The storage system 202 includes a file system 206 and physical storage devices 208A and 208B. Depending on the design details of a particular implementation, the file system 206 may be a distributed file system such as AWS S3, Network File System (NFS), Server Message Block (SMB), and others. However, the present techniques may be implemented in substantially any type of file system, including disk file systems such File Allocation Table (FAT) (and variations thereof), New Technology File System (NTFS), and others.

The physical storage devices 208A and 208B may be any type and combination of persistent (e.g., non-volatile) storage devices, including the cloud databases 141 shown in FIG. 1. Each of the storage devices 208A and 208B are accessible separately via a network (e.g., Network 105), each having different network address information, network connections, etc. For the sake of clarity, only two storage devices are shown. However, it will be appreciated that a typical data center or cloud storage service will include a large number of storage devices coupled together through a network.

The data stored to the storage devices 208A and 208B may be stored as individual data elements 214, such as blocks or data objects (sometimes referred to as blobs). As shown in FIG. 2, the data elements 214 associated with a single file may be distributed across multiple computing systems and/or storage devices 208A and 208B.

As shown in FIG. 2, the file system 206 may include a table (e.g., key-value store) used to map files to the physical storage locations associated with the stored file contents. In some cases, the table may be stored at a single server referred to as a master node or metadata node. In other cases, the table may be partitioned and the partitions may be distributed among a plurality of servers, in which case, the servers configured for the storage and handling of file system data may be referred to collectively as the master node or metadata node.

Each entry in the table (shown as individual rows) includes a path field 210 and a pointer field 212 that corresponds with a particular file that has been stored to the storage system 202. The path field 210 may contain a path that uniquely identifies a file within the storage system 202. The path may include a directory name and a file name. If the file system table is a key-value store, the path may be referred to as the key and the contents of a file may be referred to as the value. The pointer field 212 may contain one or more pointers that identify the storage locations within the physical storage 208 that contain the contents of the file.

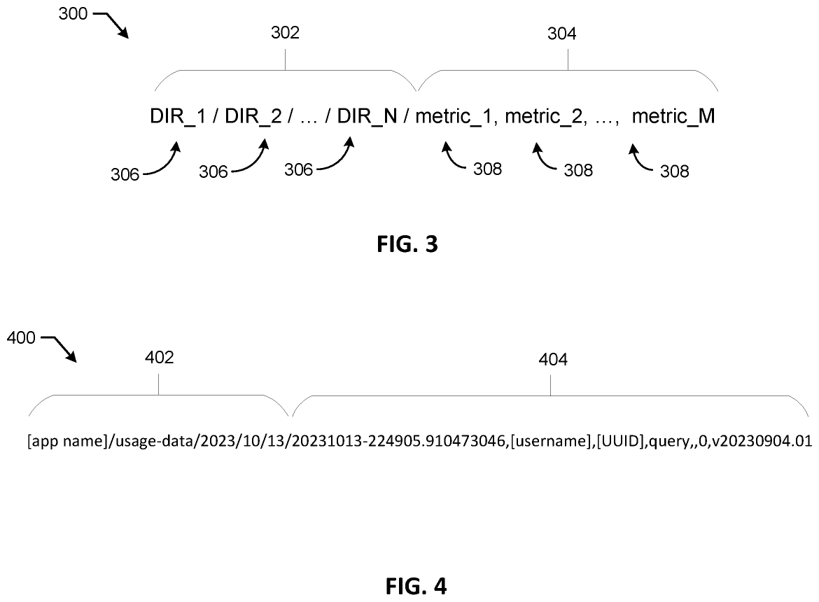

To write telemetry data 218 to the file system 206, the telemetry generator 204 writes zero-byte files to the storage system 202 and encodes the telemetry data within the path (e.g., the file name). The directory name may be used to organize the telemetry data 218 by partitioning the telemetry data across various groupings. Example paths that can be used to organize and encode telemetry data 218 are described further in relation to FIGS. 3 and 4.

Each unit of telemetry data 218 may be represented as a separate entry in the table of the file system 206. When a telemetry data file is created, the file system 206 adds a corresponding entry in the file system table but does not record file contents on the physical storage 208. Because the telemetry data 218 is made up of zero-byte files, the table entries associated with telemetry data 218 do not reference locations within physical storage 208. Accordingly, the pointer field 212 for telemetry data entries may be empty or null as shown FIG. 2.

Telemetry data stored to the file system 206 may be retrieved by the telemetry consumer 206. The telemetry consumer 206 may be a user interface (e.g., graphical user interface, command line interface) operated, for example, by a software developer or system administrator. Through the user interface, the telemetry consumer 206 may enable a human operator to visually inspect the telemetry data 218 using commands (e.g., “Is” commands) configured to cause the file system 206 to return a list the files and/or directories within the file system 206.

The telemetry consumer 206 may also be a process (e.g., software program or service) configured to obtain the stored telemetry data 218 for further processing in an automated fashion. For example, the telemetry consumer 206 may be programmed to collect stored telemetry data 218, according to a preset schedule, periodic time intervals, or in response to a user request. The collected telemetry data 218 may be processed to extract the telemetry data metrics from each of the file names. These metrics may be further processed by analysis software to develop insights and/or stored in a database, such as a relational database. Storing the metrics to a relational database enables the metrics to be queried by a human user and/or the analysis software.

In such embodiments, the telemetry consumer 206 may be a cloud service 120 or other application executing within the same cloud-computing environment 100. In other embodiments, the telemetry consumer 206 may be an application running on a user's computing device (e.g., client device 101). In some embodiments, the telemetry consumer 206 may access the storage system 202 through a file system API made available by the cloud service provider. Storage resources of the storage system 202 may be mounted so that it operates like a local drive or local folder from the perspective of the telemetry consumer 206. In this way, the telemetry consumer 206 can be programmed to obtain telemetry data using simple commands for reading files.

FIG. 3 is an example file path format for storing telemetry data to a file system, in accordance with some embodiments of the present disclosure. As shown in FIG. 3, the path includes a directory name 302 with several directories 306 (also referred to as folders) labeled “dir_1” to “dir_N”, where “N” is any positive integer (or zero if directories are not used). The path also includes a file name 304 made up of several metrics 308 labeled “metric_1” to “metric_M”, where “M” is any positive integer. The path may include any suitable number of directories, N, and any suitable number of metrics, M, up to the number of characters supported by the file system.

Each directory 306 represents a different partition (e.g., shard) by which the telemetry data may be organized. For example, the telemetry data may be partitioned according to the source of the telemetry data (e.g., the application or service generating the telemetry data, a computing device generating the telemetry data, user associated with the telemetry data, etc.), the type of telemetry data (e.g., usage data, security data, runtime error data), a date that the telemetry data was generated (e.g., year, month, day), and others. Partitioning the telemetry data in this way enables data retrieval to be accomplished through range scans of the file system 206 to acquire telemetry data associated with selected directories, e.g., a selected source, a selected data type, a selected date or range of dates, among others.

The metrics 308 are the data values that make up a unit of telemetry data. The metrics 308 can include any type of information that may be useful for evaluating an application, including performance statistics, resource consumption statistics, usage information, and others. For example, various metrics 308 may be used to provide date and time information, usernames, device identifiers (e.g., Universally Unique Identifier (UUID)), performance statistics, resource consumption statistics, user actions, error codes, version information, and others.

The file name 304 may be character delimited to separate the individual metrics 308. In FIG. 3, the file name 304 is comma delimited. However, any suitable character may be used as a delimiter, taking into consideration any potential character restrictions imposed by the file system. The delimiting character enables collected telemetry data to be effectively parsed to extract the individual metrics 308 as described above in relation to FIG. 2. In some embodiments, the path may have more than one delimiting character for delimiting the metrics.

It will be appreciated that the path format shown in FIG. 3 is one example of a format that can be used to organize and store telemetry data and that other formats are possible within the scope of the present disclosure. For example, in some embodiments, the path may not include any directory information, in which case, the path may be a comma delimited string of metrics without any directory designations (e.g., path=“metric_1,metric_2,metric_3”). In some embodiments, directory names may be used to store different telemetry data points rather than partitioning the metrics data as described above. For example, the delimiting character used to identify the names of directories (e.g., “/”) may be used to identify sequential units of telemetry data (e.g., path=“/metric_1,metric_2/metric_3,metric_4/metric_5,metric_6/”). In such cases, the path may represent a sequence of telemetry data points captured for an application over a period of time and stored together as a single unit of telemetry data. For example, each telemetry data point may represent an action performed by a user interacting with a monitored application over time.

FIG. 4 is a more detailed example of a file path that may be used for storing telemetry data to a file system, in accordance with some embodiments of the present disclosure. The path shown in FIG. 4 generally follows the same format shown in FIG. 3 and includes a directory name 402 and a comma-delimited file name 404. As shown in FIG. 4, the root directory contains a string of characters that identifies a particular application that generated the telemetry data. The next directory contains a string of characters that identifies the type of telemetry data as usage data. The next three directories contain strings of characters that identify the year, month, and day that the telemetry data was generated.

The file name in this example starts with a time stamp metric that includes a date and time that the telemetry data was generated. The next metric is a username, which may be the username of an account for which the telemetry data was generated. The next metric is an UUID. In some embodiments, a UUID may be generated for each unit of telemetry data written to the file system to ensure that the file names are truly unique. The use of a UUID may be beneficial in cases where other elements of the telemetry data may not be sufficient to ensure filename uniqueness. In some cases, the combination of other metrics (e.g., username, hostname, and timestamp) may be enough to provide sufficient confidence in the uniqueness of the filename without the use of a UUID.

The next metric is a string of characters that identifies a particular user action, which is a query in this instance. Additional metrics may be added to the file name to indicate details about the query, such as performance statistics, resource usage statistics, success or failure of the query, number of records returned by the query, and others. The last metric in this example is a string of characters that identify a version number. For example, the version number may identify a version of the application that created the telemetry data.

It will be appreciated that the path shown in FIG. 3 is one example of a path that can be used to organize and store telemetry data. The specific organization structure implemented via the directories and the specific types and ordering of metrics may vary depending on the design details of a particular implementation.

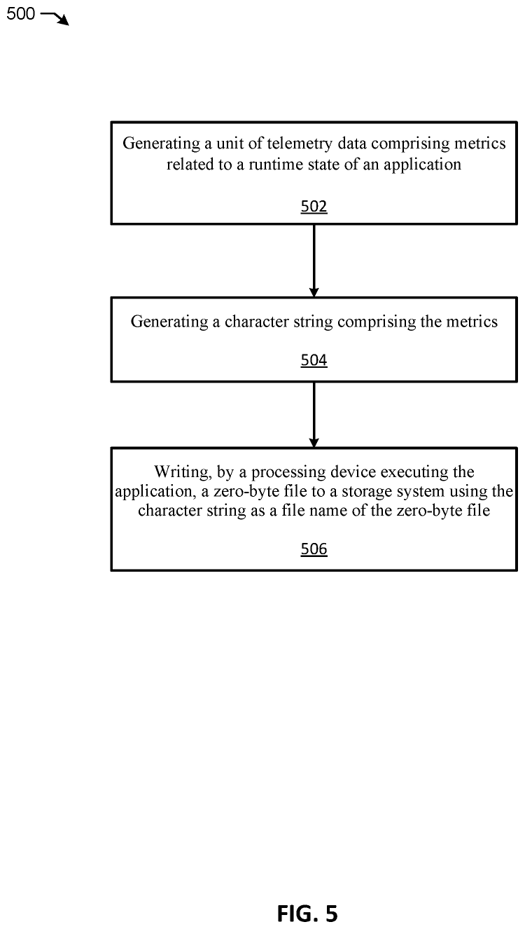

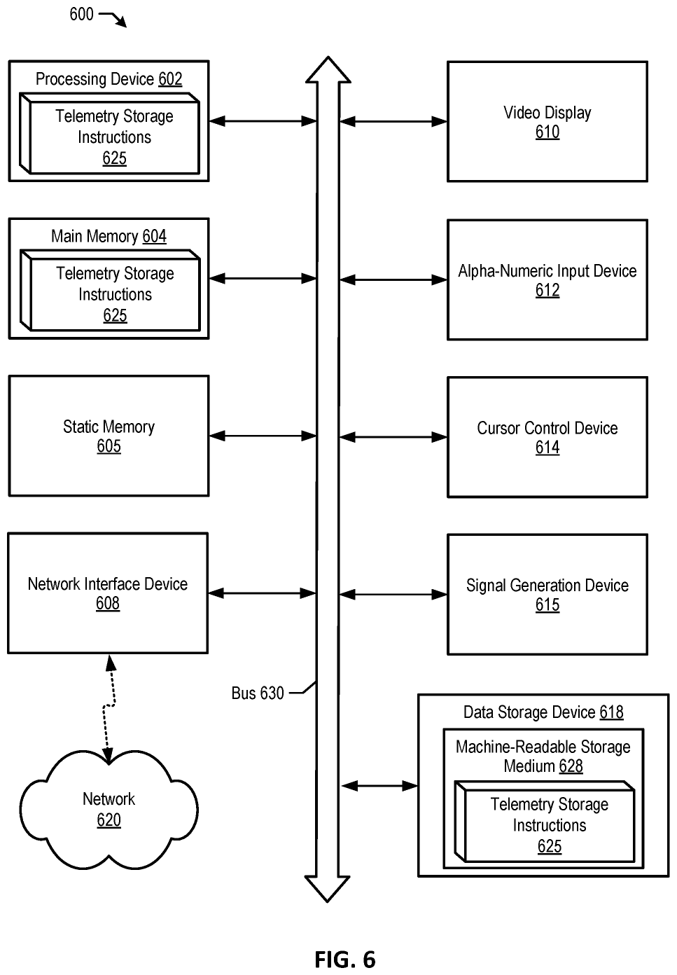

FIG. 5 is a flow diagram of a method of storing telemetry data, in accordance with some embodiments of the present disclosure. Method 500 may be performed by processing logic that may include hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 500 may be performed by the telemetry generator 204, the processing device 602 (FIG. 6), or a combination thereof.

With reference to FIG. 5, method 500 illustrates example functions used by various embodiments. Although specific function blocks (“blocks”) are disclosed in method 500, such blocks are examples. That is, embodiments are well suited to performing various other blocks or variations of the blocks recited in method 500. It is appreciated that the blocks in method 500 may be performed in an order different than presented, and that not all of the blocks in method 500 may be performed. The method 500 may begin at block 502.

At block 502, an application generates a unit of telemetry data comprising metrics related to a runtime state of the application. The application may be any process or set of instructions executed by a processor, including any computer program, service, microservice, etc. The telemetry data may include usage statistics, performance statistics, resource consumption statistics, and other data.

At block 504, a character string comprising the metrics is generated. The character string generated at block 504 is to be used as the filename of a zero-byte file. In some embodiments, an additional character string may also be generated and used as a directory name having one or more directories for organizing the telemetry data into various groupings. The character strings may be combined (e.g., concatenated) to generate a path.

At block 506, a processing device executing the application writes a zero-byte file to a storage system using the character string as a file name of the zero-byte file. The zero-byte file may also be written using the path described above, which includes both the directory name and the file name.

In some embodiments, the storage system is a distributed file system that includes a file system table that maps files to physical storage locations associated with file contents. By including the metrics in the file name, the metrics are stored to an entry of the file system table, which does not map to a physical storage location. In some embodiments, each unit of telemetry data is stored to a master node of the distributed file system. The stored telemetry data may be retrieved by issuing a command to the storage system to provide a list of directories and filenames.

FIG. 6 illustrates a diagrammatic representation of a machine in the example form of a computer system 600 within which a set of instructions, for causing the machine to perform any one or more of the methodologies discussed herein for intelligently scheduling containers.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In some embodiments, computer system 600 may be representative of a server.

The computer system 600 includes a processing device 602, a main memory 604 (e.g., read-only memory (ROM), flash memory, dynamic random access memory (DRAM), a static memory 606 (e.g., flash memory, static random access memory (SRAM), etc.), and a data storage device 618 which communicate with each other via a bus 630. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Computer system 600 may further include a network interface device 608 which may communicate with a network 620. The computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse) and an acoustic signal generation device 616 (e.g., a speaker). In some embodiments, video display unit 610, alphanumeric input device 612, and cursor control device 614 may be combined into a single component or device (e.g., an LCD touch screen).

Processing device 602 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. The processing device 602 is configured to execute telemetry storage instructions 625, for performing the operations and steps discussed herein.

The data storage device 618 may include a machine-readable storage medium 628, on which is stored one or more sets of telemetry storage instructions 625 (e.g., software) embodying any one or more of the methodologies of functions described herein. The telemetry storage instructions 625 may also reside, completely or at least partially, within the main memory 604 or within the processing device 602 during execution thereof by the computer system 600; the main memory 604 and the processing device 602 also constituting machine-readable storage media. The telemetry storage instructions 625 may further be transmitted or received over a network 620 via the network interface device 608.

While the machine-readable storage medium 628 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Unless specifically stated otherwise, terms such as “generating,” “writing,” “executing,” “combining,” “detecting,” “retrieving,” “instantiating,” “receiving,” “performing,” “providing,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a,” “an” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112 (f) for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

disclosure is not to be limited to the details given herein, but may be modified within the scope and equivalents of the appended claims.

What is claimed is:

1. A method comprising:
generating, by an application, a unit of telemetry data comprising metrics related to a runtime state of the application;
generating a character string comprising the metrics; and
writing, by a processing device executing the application, a zero-byte file to a storage system using the character string as a file name of the zero-byte file.

2. The method of claim 1, further comprising:
generating an additional character string comprising a directory name, the directory name comprising one or more directories to organize the unit of telemetry data into a selected grouping;
combining the additional character string with the character string comprising the metrics to generate a path comprising the directory name and the file name; and
wherein writing the zero-byte file to the storage system comprises writing the zero-byte file using the path.

3. The method of claim 1, wherein the storage system comprises a distributed file system and wherein the unit of telemetry data is stored to a master node of the distributed file system.

4. The method of claim 1, wherein the storage system comprises a file system table that maps files to physical storage locations associated with file contents, and wherein the metrics are stored to an entry of the file system table that does not map to a physical storage location.

5. The method of claim 1, further comprising retrieving the unit of telemetry data from the storage system by issuing a command to the storage system to provide a list of directories and filenames.

6. The method of claim 1, wherein the telemetry data comprises usage statistics, performance statistics, or resource consumption statistics.

7. The method of claim 1, wherein the storage system comprises a distributed file system operating on a cloud computing platform.

8. The method of claim 7, wherein the application is executing on computing resources of the cloud computing platform.

9. The method of claim 1, wherein the application is executing on a client device coupled to the storage system through a network.

10. The method of claim 1, wherein the character string is character delimited to separate each of the metrics.

11. A system comprising:
a processing device; and
a memory to store instructions that, when executed by the processing device, cause the processing device to:
generate a unit of telemetry data comprising metrics related to a runtime state of an application;
generate a character string comprising the metrics; and
write a zero-byte file to a storage system using the character string as a file name of the zero-byte file.

12. The system of claim 11, wherein the processing device is further to:
generate an additional character string comprising a directory name, the directory name comprising one or more directories to organize the unit of telemetry data into a selected grouping;
combine the additional character string with the character string comprising the metrics to generate a path comprising the directory name and the file name; and
wherein writing the zero-byte file to the storage system comprises writing the zero-byte file using the path.

13. The system of claim 11, wherein the storage system comprises a distributed file system and wherein the unit of telemetry data is stored to a master node of the distributed file system.

14. The system of claim 11, wherein the storage system comprises a file system table that maps files to physical storage locations associated with file contents, and wherein the metrics are stored to an entry of the file system table that does not map to a physical storage location.

15. The system of claim 11, wherein the processing device is further to retrieve the unit of telemetry data from the storage system by issuing a command to the storage system to provide a list of directories and filenames.

16. The system of claim 11, wherein the telemetry data comprises usage statistics, performance statistics, or resource consumption statistics.

17. The system of claim 11, wherein the storage system comprises a distributed file system operating on a cloud computing platform.

18. The system of claim 17, wherein the application is executing on computing resources of the cloud computing platform.

19. The system of claim 11, wherein the application is executing on a client device coupled to the storage system through a network.

20. The system of claim 11, wherein the character string is character delimited to separate each of the metrics.

21. A non-transitory computer readable medium, having instructions stored thereon which, when executed by a processing device, cause the processing device to:
generate a unit of telemetry data comprising metrics related to a runtime state of an application;
generate a character string comprising the metrics; and
write, by the processing device, a zero-byte file to a storage system using the character string as a file name of the zero-byte file.

22. The non-transitory computer readable medium of claim 21, wherein the processing device is to:
generate an additional character string comprising a directory name, the directory name comprising one or more directories to organize the unit of telemetry data into a selected grouping;
combine the additional character string with the character string comprising the metrics to generate a path comprising the directory name and the file name; and
wherein writing the zero-byte file to the storage system comprises writing the zero-byte file using the path.

23. The non-transitory computer readable medium of claim 21, wherein the storage system comprises a distributed file system and wherein the unit of telemetry data is stored to a master node of the distributed file system.

24. The non-transitory computer readable medium of claim 21, wherein the storage system comprises a file system table that maps files to physical storage locations associated with file contents, and wherein the metrics are stored to an entry of the file system table that does not map to a physical storage location.

25. The non-transitory computer readable medium of claim 21, wherein the processing device is further to retrieve the unit of telemetry data from the storage system by issuing a command to the storage system to provide a list of directories and filenames.

26. The non-transitory computer readable medium of claim 21, wherein the telemetry data comprises usage statistics, performance statistics, or resource consumption statistics.

27. The non-transitory computer readable medium of claim 21, wherein the storage system comprises a distributed file system operating on a cloud computing platform.

28. The non-transitory computer readable medium of claim 27, wherein the application is executing on computing resources of the cloud computing platform.

29. The non-transitory computer readable medium of claim 21, wherein the application is executing on a client device coupled to the storage system through a network.

30. The non-transitory computer readable medium of claim 21, wherein the character string is character delimited to separate each of the metrics.
